(19) United States
(12) Patent Application Publication
(10) Pub. No.: US 2026/0343564 A1
(43) Pub. Date: Oct. 29, 2026

(54) SIDELINK SENSING INFORMATION SHARING

(71) Applicant: TOYOTA JIDOSHA KABUSHIKI KAISHA, Toyota-shi, Aichi-ken (JP)

(72) Inventors: Kai-Erik SUNELL, Naantali (FI); Takayuki SHIMIZU, Mountain View, CA (US); Claude ARZELIER, Varna (BG); Faranaz SABOURI-SICHANI, Aalborg Oe (DK); Thomas JACOBSEN, Noerresundby (DK); Nuno KIILERICH PRATAS, Gistrup (DK)

(73) Assignee: TOYOTA JIDOSHA KABUSHIKI KAISHA, Toyota-shi, Aichi-ken (JP)

(21) Appl. No.: 19/102,507

(22) PCT Filed: Jul. 20, 2023
(86) PCT No.: PCT/JP2023/026560

§ 371 Date: Feb. 10, 2025

Related U.S. Application Data
(60) Provisional application No. 63/396,857, filed on Aug. 10, 2022.

(51) Int. Cl. H04W 72/25; H04W 4/02; H04W 4/40; H04W 16/14

(52) U.S. Cl. CPC H04W 72/25; H04W 4/023; H04W 16/14; H04W 4/40

(57) ABSTRACT

Disclosed are methods, apparatuses, and systems for a packet structure selection for a device in a first sidelink communication. The method includes: determining, by the device, whether the device coexists with a second sidelink communication; deciding, by the device, whether to append a control signal or data for the second sidelink communication to a packet for the first sidelink communication based on a result of the determining; and performing, by the device, a resource selection or reselection based on a result of the deciding.

### CROSS-REFERENCE TO RELATED PATENT APPLICATION

This application is a national phase of International Application No. PCT/JP2023/026584, filed on Jul. 20, 2023, which claims the benefit of U.S. Provisional Application No. 63/371, 028, filed on Aug. 10, 2022, entitled “SIDELINK PACKET STRUCTURES FOR FAIR CO-CHANNEL COEXISTENCE OF LTE SIDELINK, NR SIDELINK, AND NEXT GENERATION SIDELINK,” the entirety of both of which is incorporated by reference herein.

### TECHNICAL FIELD

Apparatuses and methods consistent with the present disclosure relate generally to communications, more specifically, methods, systems, and devices for packet structures in sidelink communications.

### BACKGROUND ART

Sidelink communication technology enables direct communication between two devices. When a first device in a first sidelink communication shares radio resources with a second device in a second sidelink communication, the first device and the second device select radio resources for use. If the first device includes modules for both the first and second sidelink communications, and the second device only includes the module for the second sidelink communication, which is a common situation in sidelink communications, the selection of radio resources could be unfavorable for the first device. For example, when the first device is able to decode the resource information related to the second sidelink communication and avoids selection of the resources reserved by the second device, the second device may be unable to decode the resource information related to the first sidelink communication and may select the resources reserved by the first device, causing resource depletion for the first device. Improved systems and methods for fair resource selection are desired.

The resource selection procedure of 3rd Generation Partnership Project (3GPP) Release 16/17 5G New Radio (NR) vehicle-to-everything (V2X) PC5 mode 2 is specified in 3GPP Technical Specification (TS) 38.213, TS 38.214, and TS 38.321. For resource selection, a UE performs channel sensing in a sensing window and collects another UE's resource reservation information based on sidelink control information (SCI) decoding to identify candidate resources in a selection window T (T=[T₁, T₂]). First, the UE excludes some time slots from the selection window due to unmonitored resources in the sensing window that the UE cannot sense due to its own transmission (i.e., half-duplex constraint). Then, the UE further excludes resources reserved by other UEs from the selection window if the corresponding sidelink-reference signal received power (SL-RSRP) exceeds the (pre-) configured SL-RSRP exclusion threshold. After resource exclusion, the number of candidate resources shall be at least X% of the total number of resources in the selection window. Otherwise, UE increases SL-RSRP exclusion threshold by 3 dB until obtaining at least X% resources, where X is (pre-) configured from {20, 35, 50}%. Finally, the UE randomly selects resources among candidate resources in the selection window. The selected frequency resource can be used for multiple times with a fixed time interval for subsequent transmissions (i.e., semi-persistent scheduling (SPS)) or only once (i.e., one-shot transmission (OST)). Also, the UE can retransmit packets multiple times (i.e., hybrid automatic repeat request (HARQ) retransmissions) with or without feedback from receiver UEs to improve the reliability.

In order for a UE to perform sensing and obtain information to receive other UEs' packets, the UE decodes SCI first. In Rel-16, there are 1^{st}-stage SCI (SCI format 1-A) and 2^{nd}-stage SCI (SCI format 2-A or 2-B) as defined in 3GPP TS 38.212. 1^{st}-stage SCI carries resource reservation information for future transmissions, as well as information about resource allocation and modulation and coding scheme (MCS) for physical sidelink shared channel (PSSCH), demodulation reference signal (DMRS) pattern, 2^{nd}-stage SCI format, etc. 2^{nd}-stage SCI carries control information for HARQ procedures, source/destination IDs, information for distance-based groupcast (UE's zone identification (ID) and communication range requirement), etc.

Based on the resource reservation contained in 1^{st}-stage SCI, each UE avoids using reserved time/frequency resources by other UEs when it performs resource (re-) selection. In Rel-17 5G NR-V2X PC5 mode 2, inter-UE coordination (IUC) is introduced, in which a UE-A sends coordination information about resources to a UE-B, and then the UE-B utilizes that information for its resource (re-) selection. The following schemes of inter-UE coordination are supported:
IUC scheme 1: A UE-A can provide to another UE-B indications of resources that are preferred to be included in UE-B's (re-) selected resources, or preferred to be excluded. When given resources to include, UE-B may rely only on those resources, at least if it does not support sensing/resource exclusion, or may combine them with resources identified by its own sensing procedure, before making a final selection. The indication from UE-A to UE-B is sent in medium access control (MAC) control element (CE) and/or 2^{nd}-stage SCI.
IUC scheme 2: A UE-A can provide to another UE-B an indication that resources reserved for UE-B's transmission (which may or may not be to UE-A) will be, or could be, subject to conflict with a transmission from another UE.

Then, UE-B re-selects new resources to replace them. The indication from UE-A to UE-B is sent in a physical sidelink feedback channel (PSFCH).

### SUMMARY OF INVENTION

According to some embodiments of the present disclosure, there is provided a method for a packet structure selection for a device in a first sidelink communication. The method includes: determining, by the device, whether the device coexists with a second sidelink communication; deciding, by the device, whether to append a control signal or data for the second sidelink communication to a packet for the first sidelink communication based on a result of the determining; and performing, by the device, a resource selection or reselection based on a result of the deciding.

According to some embodiments of the present disclosure, there is provided another method for a packet structure selection for a device in a first sidelink communication. The method includes: determining, by the device, whether a dynamic packet structure selection is enabled for reducing a control signal or data overhead for a second sidelink communication; and appending, in response to a determination that the dynamic packet structure selection is not enabled for reducing the control signal or data overhead for the second sidelink communication, a control signal or data for the second sidelink communication to a packet for the first sidelink communication.

According to some embodiments of the present disclosure, there is provided another method for a packet structure selection for a device in a first sidelink communication. The method includes: determining, by the device, whether the device coexists with a second sidelink communication and a third sidelink communication; and deciding, based on a result of the determining, whether to append at least one of: a control signal or data for the second sidelink communication, or a control signal or data for the third sidelink communication, to a packet for the first sidelink communication.

According to some embodiments of the present disclosure, there is provided a device in a first sidelink communication. The device includes a memory storing an instruction; and a processor configured to execute the instruction stored in the memory to: determine whether the device coexists with a second sidelink communication; decide whether to append control signal or data for the second sidelink communication to a packet for the first sidelink communication based on a result of the determining; and perform a resource selection or reselection based on a result of the deciding.

According to some embodiments of the present disclosure, there is provided another device in a first sidelink communication. The device includes a memory storing an instruction; and a processor configured to execute the instruction stored in the memory to: determine whether a dynamic packet structure selection is enabled for reducing a control signal or data overhead for a second sidelink communication; and append, in response to a determination that the dynamic packet structure selection is not enabled for reducing the control signal or data overhead for the second sidelink communication, a control signal or data for the second sidelink communication to a packet for the first sidelink communication.

According to some embodiments of the present disclosure, there is provided another device in a first sidelink communication. The device includes a memory storing an instruction; and a processor configured to execute the instruction stored in the memory to: determine whether the device coexists with a second sidelink communication and a third sidelink communication; and decide, based on a result of the determining, whether to append at least one of: a control signal or data for the second sidelink communication, or a control signal or data for the third sidelink communication, to a packet for the first sidelink communication.

According to some embodiments of the present disclosure, there is provided a non-transitory computer-readable medium storing instructions that are executable by one or more processors of a device in a first sidelink communication to perform a method. The method includes: determining whether the device coexists with a second sidelink communication; deciding whether to append a control signal or data for the second sidelink communication to a packet for the first sidelink communication based on a result of the determining; and performing a resource selection or reselection based on a result of the deciding.

According to some embodiments of the present disclosure, there is provided another non-transitory computer-readable medium storing instructions that are executable by one or more processors of a device in a first sidelink communication to perform a method. The method includes: determining, by the device, whether a dynamic packet structure selection is enabled for reducing a control signal or data overhead for a second sidelink communication; and appending, in response to a determination that the dynamic packet structure selection is not enabled for reducing a control signal or data overhead for the second sidelink communication, a control signal or data for the second sidelink communication to a packet for the first sidelink communication.

According to some embodiments of the present disclosure, there is provided another non-transitory computer-readable medium storing instructions that are executable by one or more processors of a device in a first sidelink communication to perform a method. The method includes: determining whether the device coexists with a second sidelink communication and a third sidelink communication; and deciding, based on a result of the determining, whether to append at least one of: a control signal or data for the second sidelink communication, or a control signal or data for the third sidelink communication, to a packet for the first sidelink communication.

### BRIEF DESCRIPTION OF DRAWINGS

FIG. 1 is a flow chart illustrating a method for resource selection in a sidelink communication, consistent with some embodiments of the present disclosure.

FIG. 2 is a schematic diagram illustrating a resource candidate determination procedure according to the method of FIG. 1, consistent with some embodiments of the present disclosure.

FIG. 3 is a schematic diagram illustrating a sidelink packet structure used in the method of FIG. 1, consistent with some embodiments of the present disclosure.

FIG. 4 is a flow chart illustrating a method for resource selection in a sidelink communication, consistent with some embodiments of the present disclosure.

FIG. 5A is a schematic diagram illustrating a resource candidate determination procedure according to the method of FIG. 4, consistent with some embodiments of the present disclosure.

FIG. 5B is a table showing a correspondence between sub-carrier spacing and a subset of resources according to the method of FIG. 4, consistent with some embodiments of the present disclosure.

FIG. 6A is a schematic diagram illustrating a sidelink packet structure used in the method of FIG. 4, consistent with some embodiments of the present disclosure.

FIG. 6B is a schematic diagram illustrating another sidelink packet structure used in the method of FIG. 4, consistent with some embodiments of the present disclosure.

FIG. 7 is a schematic diagram illustrating a dynamic co-channel coexistence of a first sidelink communication and a second sidelink communication, consistent with some embodiments of the present disclosure.

FIG. 8 is a schematic diagram illustrating device types for a dynamic co-channel coexistence of a first sidelink communication and a second sidelink communication, consistent with some embodiments of the present disclosure.

FIG. 9A is a schematic diagram illustrating fairness issues in a dynamic co-channel coexistence of a Type A device and a Type C device, consistent with some embodiments of the present disclosure.

FIG. 9B is a schematic diagram illustrating fairness issues in a dynamic co-channel coexistence of a Type A device and a Type C device, consistent with some embodiments of the present disclosure.

FIG. 10A is a schematic diagram illustrating a semi-static resource pool configuration in time domain multiplexing (TDM) for a co-channel coexistence of a first sidelink communication and a second sidelink communication, consistent with some embodiments of the present disclosure.

FIG. 10B is a schematic diagram illustrating a semi-static resource pool configuration in frequency domain multiplexing (FDM) for a co-channel coexistence of the first sidelink communication and the second sidelink communication, consistent with some embodiments of the present disclosure.

FIG. 11 is a schematic diagram illustrating a fair co-channel coexistence of a first sidelink communication and a second sidelink communication, consistent with some embodiments of the present disclosure.

FIG. 12 is a schematic diagram illustrating a new first sidelink communication packet structure for a fair co-channel coexistence of the first sidelink communication and the second sidelink communication, consistent with some embodiments of the present disclosure.

FIG. 13A is a schematic diagram illustrating a sidelink communication packet structure for a fair co-channel coexistence of a second sidelink communication and a third sidelink communication, consistent with some embodiments of the present disclosure.

FIG. 13B is a schematic diagram illustrating a sidelink communication packet structure for a fair co-channel coexistence of a first sidelink communication and the third sidelink communication, consistent with some embodiments of the present disclosure.

FIG. 13C is a schematic diagram illustrating a sidelink communication packet structure for a fair co-channel coexistence of the first, second, and third sidelink communications, consistent with some embodiments of the present disclosure.

FIG. 14 is a flow chart illustrating a method for a packet structure selection in sidelink communications, consistent with some embodiments of the present disclosure.

FIG. 15 is a schematic diagram illustrating a method for a packet structure selection in sidelink communications, consistent with some embodiments of the present disclosure.

FIG. 16 is a schematic diagram illustrating a method for a packet structure selection for in sidelink communications, consistent with some embodiments of the present disclosure.

FIG. 17 is a block diagram of a UE, consistent with some embodiments of the present disclosure.

### DESCRIPTION OF EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of systems, apparatuses, and methods consistent with aspects related to the present disclosure as recited in the appended claims.

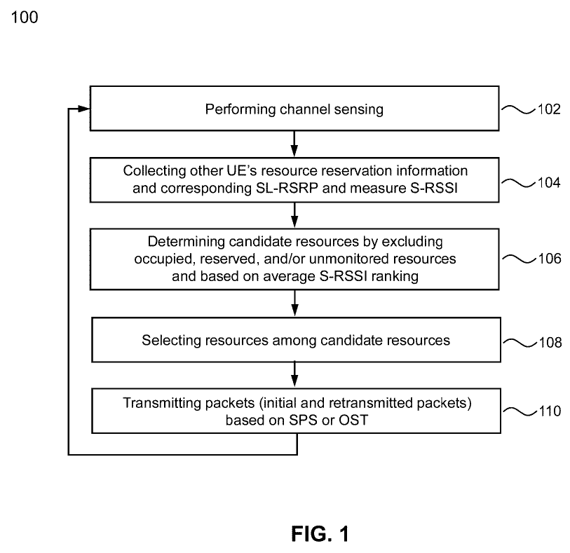

FIG. 1 is a flow chart illustrating a method 100 (referred to as the “first method” in this disclosure) for resource selection in a sidelink communication; and

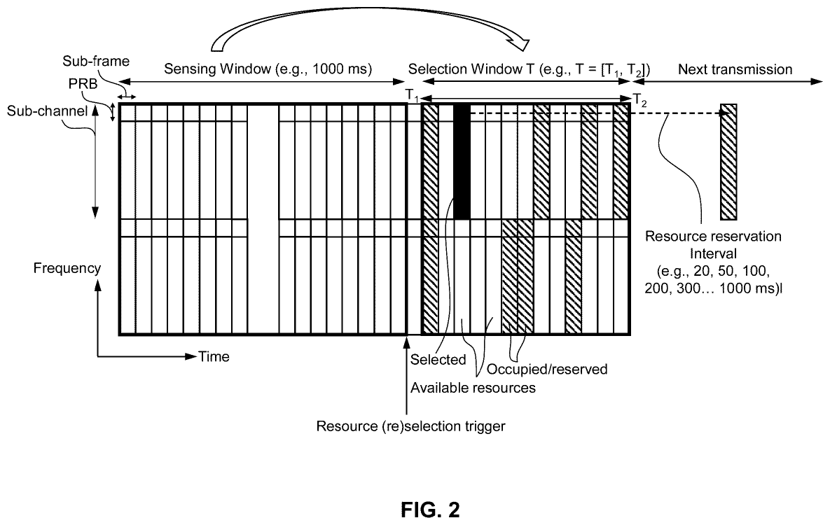

FIG. 2 is a schematic diagram illustrating a resource candidate determination procedure according to the first method, consistent with some embodiments of the present disclosure. The method 100 may be performed by a UE in a sidelink communication. For example, the method 100 may be performed by a vehicle in a V2X communication. The method 100 may be performed under a mode (referred to as the “first mode” in this disclosure) that employs discrete Fourier transform spread orthogonal frequency division multiplexing (DFT-s-OFDM) for sidelink at the physical (PHY) layer. An example of the first mode is the 3rd Generation Partnership Project (3GPP) Release 14/15 Long-Term Evolution (LTE) V2X PC5 mode 4.

As shown in FIG. 2, in the first mode, the time-frequency radio resources are divided into sub-frames in the time domain and sub-channels in the frequency domain. In an embodiment, the first mode may only support 15 kHz sub-carrier spacing (SCS). Each sub-frame may be 1 ms length and may consist of 14 DFT-s-OFDM symbols. Each sub-channel may consist of multiple contiguous physical resource blocks (PRBs), where each PRB occupies 180 kHz and consists of 12 subcarriers with 15 kHz SCS. The size of sub-channel (i.e., the number of PRBs per sub-channel) may be configurable or preconfigurable. To cope with high Doppler caused by high relative speed in vehicular scenarios, the density of demodulation reference signal (DMRS), which is used for frequency offset compensation and channel estimation, may be set to four per sub-frame. Each UE may broadcast data (e.g., transport block (TB)) in the physical sidelink shared channel (PSSCH) and sidelink control information (SCI) in the physical sidelink control channel (PSCCH). The PSCCH may occupy two contiguous PRBs. The number of PRBs for PSSCH may be configurable or preconfigurable. The SCI format may contain information to decode the corresponding TB in PSSCH and facilitate UE autonomous resource selection. As shown in FIG. 2, the resource reservation interval can be set to one of the allowed values (e.g., 20, 50, 100, 200, 300 . . . 1000 ms). PSCCH and the corresponding PSSCH may be transmitted in the same sub-frame in either adjacent or non-adjacent PRBs in the frequency domain.

Referring to FIG. 1, method 100 includes a step 102 of performing a channel sensing. For example, as shown in FIG. 2, for resource selection, a UE may perform channel sensing in a sensing window (e.g., 1000 ms) to collect another UE's resource reservation information. The sensing window can be any time duration, depending on the UE implementation.

Referring back to FIG. 1, the method 100 includes a step 104 of collecting another UE's resource reservation information and corresponding Sidelink Reference Signal Received Power (SL-RSRP), and measuring Sidelink Received Signal Strength Indicator (S-RSSI). For example, the UE may collect resource reservation information of other UEs and the corresponding SL-RSRPs. The UE may also measure the S-RSSI using received sidelink signals. The UE may decode received SCI included in the received sidelink signals to identify candidate resources in a selection window T (e.g., T=[T₁, T₂], where T₁=4 ms, and 20≤T₂=100 ms), as shown in FIG. 2. The selection of the T₁ and T₂ values depends on the UE implementation.

The method 100 includes a step 106 of determining candidate resources by excluding occupied, reserved, and/or unmonitored resources and based on an average S-RSSI ranking. For example, as shown in FIG. 2, once the resource selection or reselection is triggered, the UE may exclude some sub-frames from the selection window. The excluded sub-frames may be the resources not monitored in the sensing window. The UE may not sense these resources due to, for example, its own transmission (e.g., half-duplex constraint). The UE may further exclude resources occupied or reserved by other UEs from the selection window if the corresponding SL-RSRP exceeds a configured or preconfigured SL-RSRP exclusion threshold. After resource exclusion, the number of candidate resources may be at least 20% of the total number of resources in the selection window. Otherwise, the UE may increase the SL-RSRP exclusion threshold by, for example, 3 dB until the candidate resources reaches at least 20% of the total resources. The UE may further calculate the corresponding S-RSSI of each sub-channel resource as a linear average over the S-RSSIs of the monitored resources with a certain interval (e.g., the averaging interval is 100 ms for a resource reservation interval of greater than or equal to 100 ms). The UE may determine, for example, 20% best resources in terms of lowest average S-RSSI as the candidate resources among the total resources in the selection window. The UE may use the 20% resources with the lowest average S-RSSI based on S-RSSI ranking as candidate resources.

The method 100 includes a step 108 of selecting resources among candidate resources. The selection of the resources among the candidate resources may be a random selection. For example, as shown in FIG. 2, the UE may select a single-subframe resource in a uniformly random manner among candidate single-subframe resources. The selected frequency resource can be used for multiple times with a fixed time interval for subsequent transmissions (this scheme is referred to as “semi-persistent scheduling (SPS) ” in this disclosure) or only once (this scheme is referred to as “one-shot transmission (OST)” in this disclosure).

The method 100 includes a step 110 of transmitting the packets based on SPS or OST. The packets can be initial or retransmitted packets. For example, the UE may transmit an initial packet using the selected resources. For another example, the UE may retransmit a packet up to one time without feedback from receiver UEs to improve reliability of the transmission (this is referred to as “blind Hybrid Automatic Repeat Request (HARQ) retransmission” in this disclosure). After the transmission, the method may start again from the step 102.

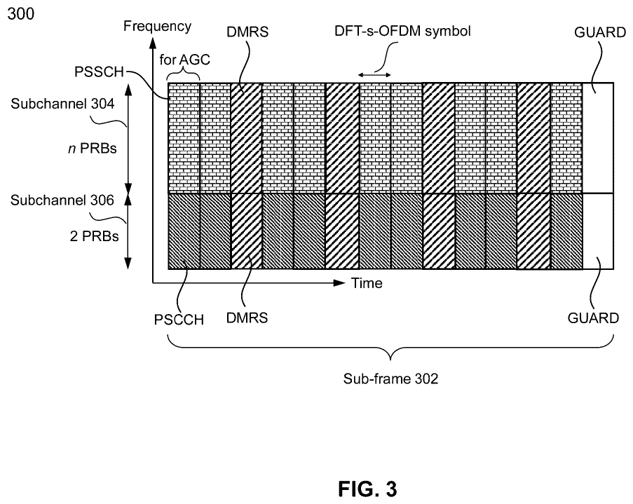

FIG. 3 is a schematic diagram illustrating a sidelink communication packet structure 300 used in the method of FIG. 1, consistent with some embodiments of the present disclosure. The packet structure 300 may be used by a UE in a sidelink communication for transmitting or receiving packets. The term “packet” used in this disclosure can be a signal, a data, one or more control signals, one or more data signals, one or more frames, one or more sub-frames, one or more slots. For example, the packet structure 300 may be used by a vehicle in a V2X communication. The packet structure 300 may be used under the first mode. As shown in FIG. 3, in the time domain, the packet structure 300 includes a sub-frame 302 that includes 14 DFT-s-OFDM symbols, in which four of the symbols are used for the DMRS, one of the symbols is used for a guard period, and the rest of the symbols are used for the PSCCH or PSSCH. The first symbol of the sub-frame 302 may be used for automatic gain control (AGC). In the frequency domain, the packet structure 300 includes a subchannel 304 consisting of n PRBs and a subchannel 306 consisting of two PRBs.

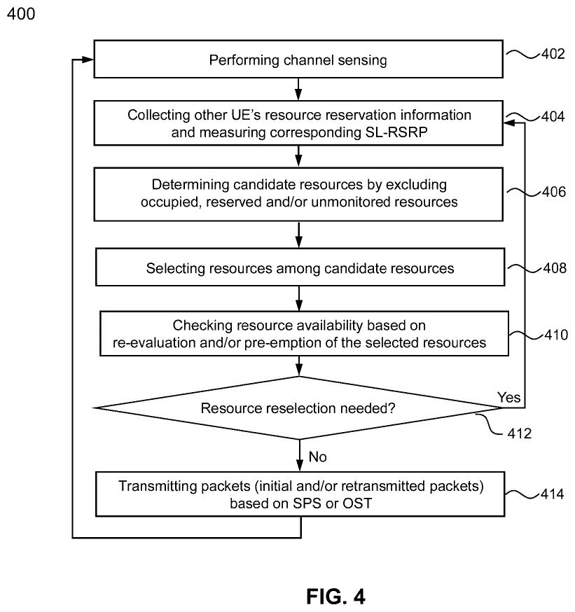

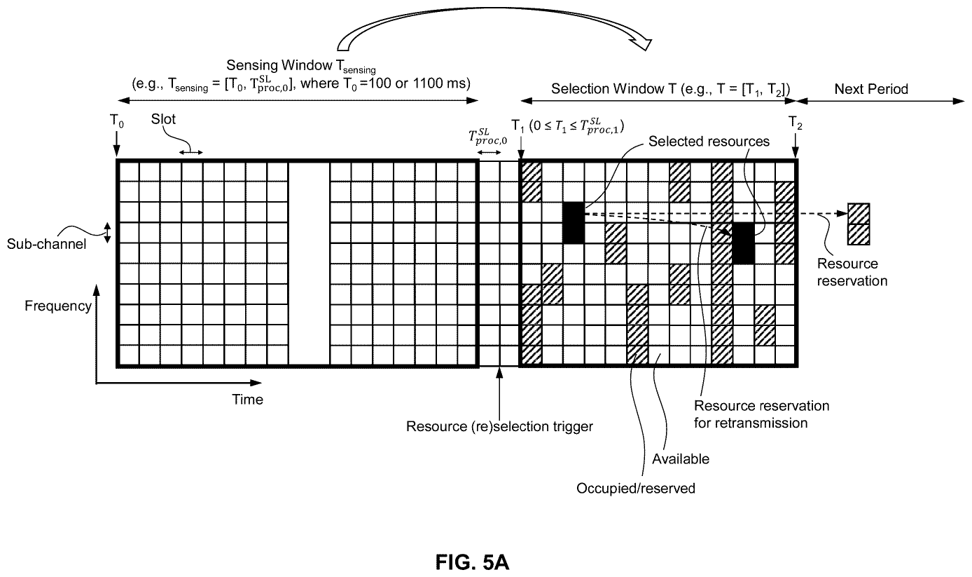

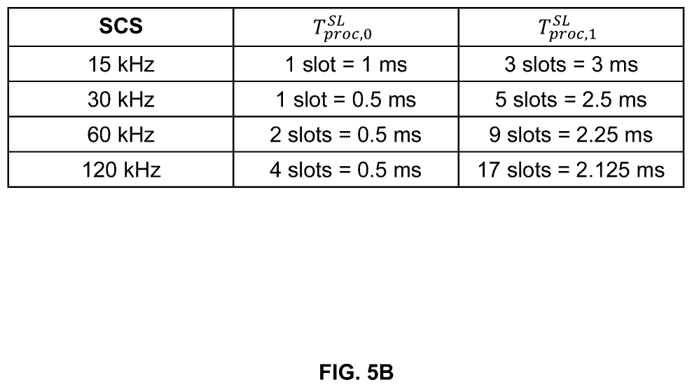

FIG. 4 is a flow chart illustrating a method 400 (referred to as the “second method” in this disclosure) for resource selection in a sidelink communication; FIG. 5A is a schematic diagram illustrating a resource candidate determination procedure according to the second method; and FIG. 5B is a table showing a correspondence between SCS and a subset of resources according to the second method, consistent with some embodiments of the present disclosure. The method 400 may be performed by a UE in a sidelink communication. For example, the method 400 may be performed by a vehicle in a V2X communication. The method 400 may be performed under a mode (referred to as the “second mode” in this disclosure) that employs orthogonal frequency division multiplexing (OFDM) at the PHY layer for sidelink communications. An example of the second mode is the 3GPP Release 16/17 5G NR-V2X PC5 mode 2.

As shown in FIG. 5A, in the second mode, the time-frequency radio resources are divided into slots in the time domain and sub-channels in the frequency domain. In an embodiment, the second mode may support SCSs of 15·2^{μ} kHz, where μ is the OFDM numerology μ∈{0, 1, 2, 3, 4}. For 6 GHz frequency band, SCSs of 15, 30, and 60 KHz (i.e., μ∈{0, 1, 2} ) may be supported, whereas for above 6 GHz frequency band, SCSs of 60, 120, and 240 kHz (i.e., μ∈{2, 3, 4} ) may be supported. Each slot is 1/2^{μ} ms length and consists of 14 OFDM symbols. Each sub-channel may consist of multiple contiguous PRBs, where each PRB occupies 180·2^{μ} KHz and consists of 12 subcarriers with 15·2^{μ} KHz SCS. The size of sub-channel (i.e., the number of PRBs per sub-channel) is configurable or preconfigurable. To support multiple SCSs and different Doppler spreads, multiple DMRS density options (2~4 DMRS symbols per slot) are supported. Each UE may transmit a first stage SCI in the PSCCH and data (TB) and a second stage SCI in the PSSCH. HARQ feedback (e.g., acknowledgement (ACK)/negative acknowledgement (NACK) or NACK only) may be transmitted in the physical sidelink feedback channel (PSFCH).

FIG. 5B shows the correspondence among SCS and parameters for the sensing window and selection window (T^{SL}_{proc,0} and T^{SL}_{proc,1}), consistent with some embodiments of the present disclosure. The subset of resources can be one or more slots. For example, when the SCS is 15 kHz, as shown in the second and third columns of FIG. 5B, T^{SL}_{proc,0} corresponds to 1 ms, and T^{SL}_{proc,1} correspond to 3 ms. As another example, when the SCS is 30 KHz, T^{SL}_{proc,0} corresponds to 0.5 ms, and T^{SL}_{proc,1} correspond 2.5 ms.

Referring back to FIG. 4, the method 400 includes a step 402 of performing a channel sensing. For example, as shown in FIG. 5A, at a time T₀, a UE may perform a channel sensing in a sensing window T_{sensing} (e.g., T_{sensing}=[T₀, T^{SL}_{proc,0}], Where T₀=100 or 1100 ms and T^{SL}_{proc,0} is given in FIG. 5B) to collect another UE's resource reservation information. The channel sensing with a sensing window of 100 ms may be for an aperiodic traffic, while the channel sensing with a sensing window of 1100 ms may be for a periodic traffic.

The method 400 includes a step 404 of collecting another UE's resource reservation information and measuring corresponding SL-RSRPs. For example, as shown in FIG. 5A, the UE may perform channel sensing in the sensing window and collect another UE's resource reservation information based on SCI decoding to identify candidate resources. In an embodiment, in order to perform the channel sensing and obtain the information to receive other UEs' packets, UE decodes SCI first. The SCI decoding may include two stages: a first stage SCI (SCI format 1-A) and a second stage SCI (SCI format 2-A or 2-B) as defined in 3GPP. The first stage SCI may carry resource reservation information for future transmissions, information about resource allocation, modulation and coding scheme (MCS) for PSSCH, DMRS pattern, and the second stage SCI format, etc. The second stage SCI may carry control information for HARQ procedures, source/destination IDs, information for distance-based groupcast (e.g., UE's zone ID and communication range requirement), etc. Based on the resource reservation contained in the first stage SCI, each UE can avoid using reserved time and/or frequency resources by other UEs when the UE performs resource selection or reselection.

The method 400 may support inter-UE coordination (IUC) in which a UE-A sends coordination information about resources to a UE-B, and the UE-B utilizes that information for its resource selection or reselection. The supported schemes of IUC may include a first IUC scheme. In the first IUC scheme, the UE-A can provide to the UE-B indications of resources that are preferred to be included in UE-B's (re-) selected resources, or preferred to be excluded. In an embodiment, when an indication of resources indicates inclusion of given resources, the UE-B may solely rely on those resources, if the indication does not support sensing and/or resource exclusion. In an embodiment, the UE-B may also combine the indication of resources with resources identified by its own sensing procedure, before making a final selection. The indication from the UE-A to the UE-B may be sent in Medium Access Control (MAC) Control Element (CE) and/or 2nd-stage SCI. The supported schemes of IUC may also include a second IUC scheme. In the second IUC scheme, a UE-A can provide to a UE-B an indication that resources reserved for the UE-B's transmission (which may or may not be to the UE-A) will be, or could be, subject to conflict with a transmission from other UEs. In this case, the UE-B may re-select new resources. The indication from the UE-A to the UE-B may be sent in PSFCH.

The method 400 includes a step 406 of determining candidate resources by excluding occupied, reserved, and/or unmonitored resources. For example, the UE may exclude unmonitored slots from the selection window T (e.g., T=[T₁, T₂], where 0≤T₁≤T^{SL}_{proc,1} ms, T^{SL}_{proc,1} is given in FIG. 5B, and T₂ is set based on the remaining packet delay budget). The UE may have failed to sense the unmonitored slots in the sensing window due to, for example, its own transmission (e.g., half-duplex constraint).

The UE may further exclude resources occupied or reserved by other UEs from the selection window if the corresponding SL-RSRP exceeds a configured or preconfigured SL-RSRP exclusion threshold. After resource exclusion, the number of candidate resources may be at least X% of the total number of resources in the selection window. Otherwise, UE may increase the SL-RSRP exclusion threshold by, for example, 3 dB until at least X% resources are obtained, where X may be configured or preconfigured from {20, 35, 50} %.

The method 400 includes a step 408 of selecting resources among candidate resources. The selection may be a random selection.

For example, as shown in FIG. 5A, the UE may randomly select resources among candidate resources in the selection window. The selected frequency resource can be used for multiple times with a fixed time interval for subsequent transmissions (SPS) or only once (OST).

The method 400 includes a step 410 of checking resource availability based on re-evaluation and/or pre-emption of the selected resources. This step may be performed for the late-arriving packets (e.g., aperiodic packets) after resource selection and before the packet transmission.

The method 400 includes a step 412 of determining whether a resource reselection is needed. If it is determined that a resource reselection is needed, the method may iterate from the step 404. On the other hand, if it is determined that a resource reselection is not needed, the method may proceed with a step 414 of transmitting packets based on SPS or OST. The packets may be initial packets or retransmitted packets. The UE may also retransmit packets multiple times (e.g., HARQ retransmissions) with or without feedback from receiver UEs to improve reliability of the transmission.

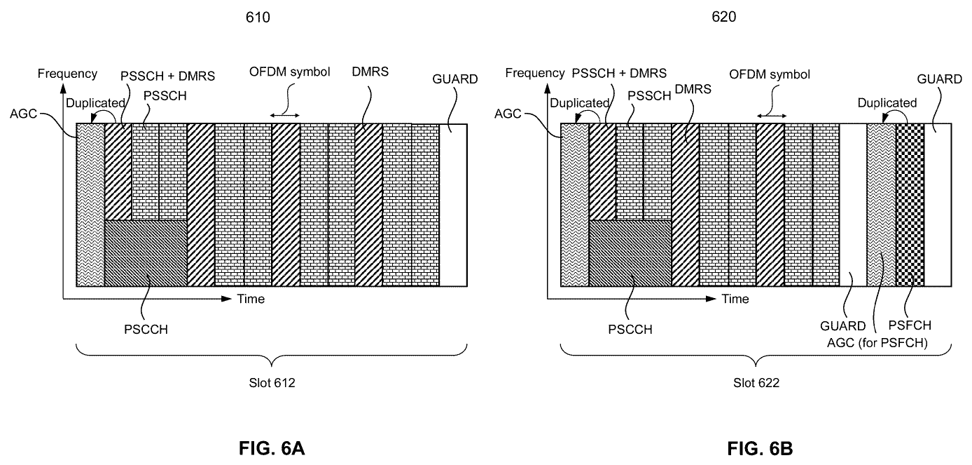

FIG. 6A is a schematic diagram illustrating a sidelink communication packet structure 610 used in the method of FIG. 4, and FIG. 6B is a schematic diagram illustrating another sidelink communication packet structure 620 used in the method of FIG. 4, consistent with some embodiments of the present disclosure. The packet structure 610 or 620 may be used by a UE in a sidelink communication for transmitting or receiving packets. For example, the packet structure 610 or 620 may be used by a vehicle in a V2X communication. The packet structure 610 or 620 may be used under the second mode. Referring to FIG. 6A, in the time domain, the packet structure 610 includes a slot 612 that includes 14 OFDM symbols for PSCCH, PSSCH, DMRS, guard period, and AGC. In the frequency domain, the packet structure 610 may include subchannels each including one or more PRBs. Referring to FIG. 6B, in the time domain, the packet structure 620 includes a slot 622 that includes 14 OFDM symbols for PSCCH, PSSCH, DMRS, guard period, AGC, and PSFCH. In the frequency domain, the packet structure 620 may include subchannels each of which including one or more PRBs. The packet structure 610 or 620 can be configured or preconfigured in a different way, for example, including a different number of symbols for PSCCH, PSSCH, or DMRS, etc.

FIG. 7 is a schematic diagram illustrating a dynamic co-channel coexistence of a first sidelink (SL) communication and a second sidelink (SL) communication, consistent with some embodiments of the present disclosure. In an embodiment, the first sidelink communication is NR sidelink communication and the second sidelink communication is LTE sidelink communication. In this embodiment, for example, the LTE sidelink communication uses 15 kHz SCS, while the NR sidelink communication uses the same or a higher SCS (e.g., 15, 30, 60 kHz). As shown in FIG. 7, the first sidelink communication and the second sidelink communication share time and/or frequency resources.

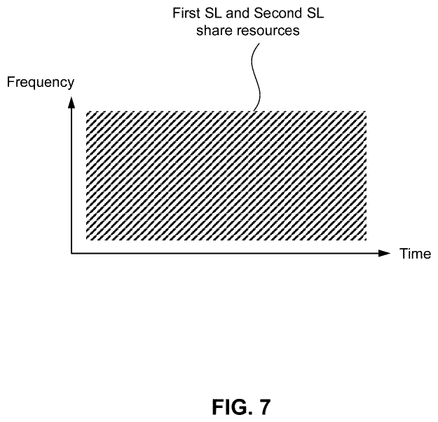

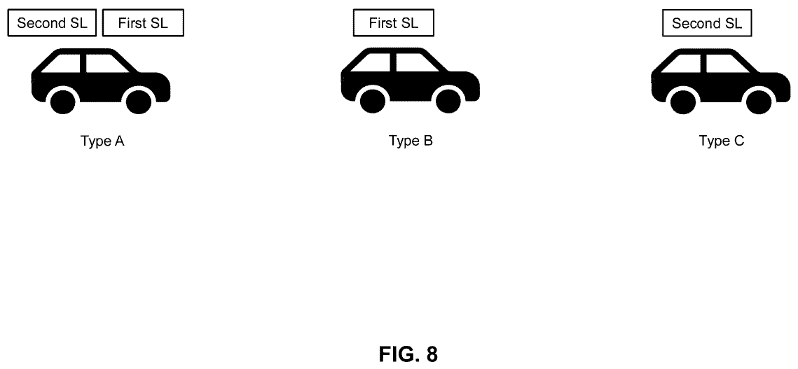

FIG. 8 is a schematic diagram illustrating device types for a dynamic co-channel coexistence of a first sidelink (SL) communication and a second sidelink (SL) communication, consistent with some embodiments of the present disclosure. Referring to FIG. 8, at least three types (Type A, Type B, and Type C) of devices are considered in this disclosure. A Type A device includes a module for the first sidelink communication (referred to as “the first module”) and a module for the second sidelink communication (referred to as “the second module”). A Type B device only includes a module for the first sidelink communication. A Type C device only include a module for the second sidelink communication. For example, in an embodiment, a Type A device includes both an LTE SL module and an NR SL module, a Type B device only includes an NR SL module, and a Type C device only includes an LTE SL module.

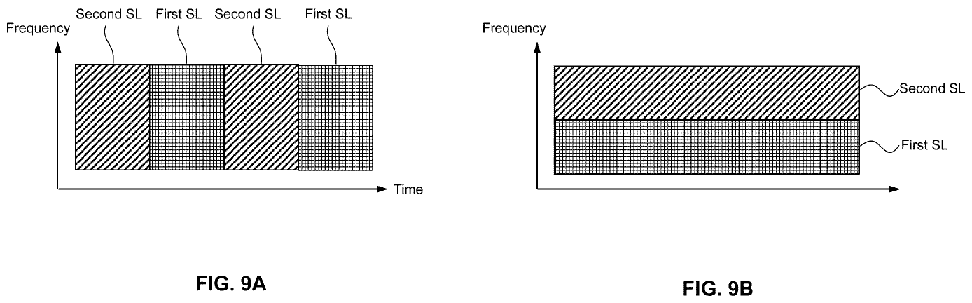

FIG. 9A and FIG. 9B are schematic diagrams illustrating fairness issues in a dynamic co-channel coexistence of a Type A device and a Type C device, consistent with some embodiments of the present disclosure. In a dynamic co-channel coexistence of a Type A device for the first sidelink communication and a Type C device for the second sidelink communication, there are fairness issues in terms of channel access. For example, as shown in FIG. 9A, a Type A device having a first SL module and a second SL module transmits a first sidelink communication packet to a Type C device that only has a second SL module. Since the first sidelink communication uses a waveform, a packet structure, and an SCI format that are different from those of the second sidelink communication, the Type C device is not able to decode the SCI of the first SL packet and thus, cannot take into account the resource reservation information of the first sidelink communication, as shown in FIG. 9A.

Referring to FIG. 9B, a Type C device transmits a second sidelink communication packet to a Type A device. Since the Type A device has both the first SL module and the second SL module, the Type A device can decode the SCI of the second sidelink communication packet and take into account the resource reservation information of the second sidelink communication. Thus, while the Type A device avoids using resources reserved by the Type C device, the Type C device may select the resources reserved by the Type A device, leading to resource depletion in the Type A device. This causes fairness issues in terms of channel access.

There may be another type of fairness issue. For example, within a Type A UE, the second module provides to the first module information about sensing results and/or resource reservation of the second module, to allow the first module to exclude resources accordingly. However, the second module is “blind” to the resource reservation of the first module. This may create a fairness issue, because the radio access technology (RAT) of the second module may over-use resources, to the detriment of the RAT of the first module.

At least some embodiments of the present disclosure allow for mitigation of the above noted fairness issues in resource selection or reselection.

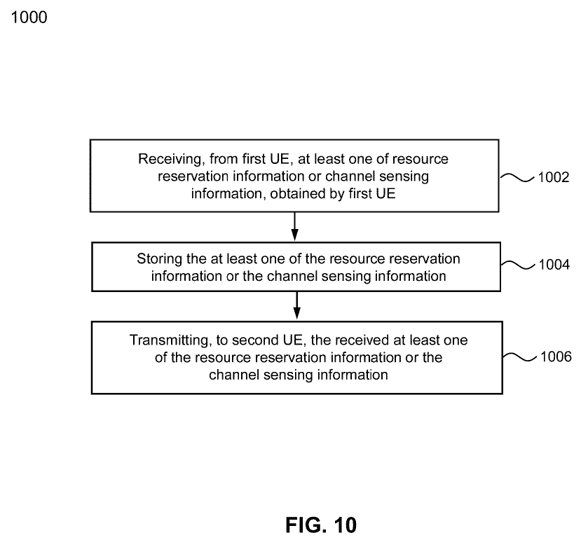

FIG. 10A is a schematic diagram illustrating a semi-static resource pool configuration in time domain multiplexing (TDM) for a co-channel coexistence of a first sidelink communication and a second sidelink communication; and FIG. 10B is a schematic diagram illustrating a semi-static resource pool configuration in frequency domain multiplexing (FDM) for a co-channel coexistence of the first sidelink communication and the second sidelink communication, consistent with some embodiments of the present disclosure. In an embodiment, the first sidelink communication is 5G NR-V2X PC5 mode 2 and the second sidelink communication is LTE-V2X PC5 mode 4. In this embodiment, different resource pools in TDM or FDM are allocated for LTE SL and NR SL in a channel. However, the semi-static approach may have drawbacks. For example, in the existing pre-configuration for LTE-V2X (e.g., Society of Automotive Engineers (SAE) J3161/1, European Telecommunications Standards Institute (ETSI) EN 303 613), all time and frequency resources are allocated for LTE SL. Therefore, once LTE SL is deployed, the update of the resource pool configuration may not be easy due to a long car life (usually longer than 10 years). Even if the update of resource pool configuration is possible for LTE SL radios already deployed, the semi-static resource pool allocation may cause under-utilization or over-utilization (e.g., channel congestion) of spectrum due to imbalance of the number of LTE SL radios and NR SL radios in a given location and/or time and the amount of allocated resource pool for each technology. In contrast, dynamic co-channel coexistence enables efficient use of spectrum because time-frequency resources are dynamically shared by LTE SL and NR SL in a distributed manner.

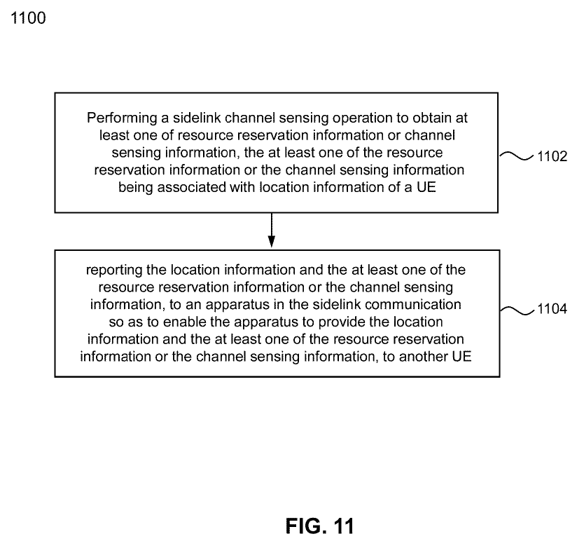

FIG. 11 is a schematic diagram illustrating a fair co-channel coexistence of a first sidelink communication and a second sidelink communication, consistent with some embodiments of the present disclosure. Referring to FIG. 11, a Type A device or a Type B device transmits a new first SL packet to a Type C device. The new first SL packet is formed by appending the second SL packet (e.g., PSCCH for the second SL) to the first SL packet (e.g., PSCCH, PSSCH, PSFCH for the first SL). The second SL packet part of the new first SL packet includes at least the resource reservation and priority of the first SL in the format of the second SL SCI by converting the first SL SCI format to the second SL SCI format. When the Type C device receives the new first SL packet, the Type C device can decode the second SL packet part of the new first SL packet and thus, can obtain the resource reservation and priority of the first SL in the second SL SCI format. Then, the Type C device can take into account the received first SL resource reservation for the resource selection or reselection.

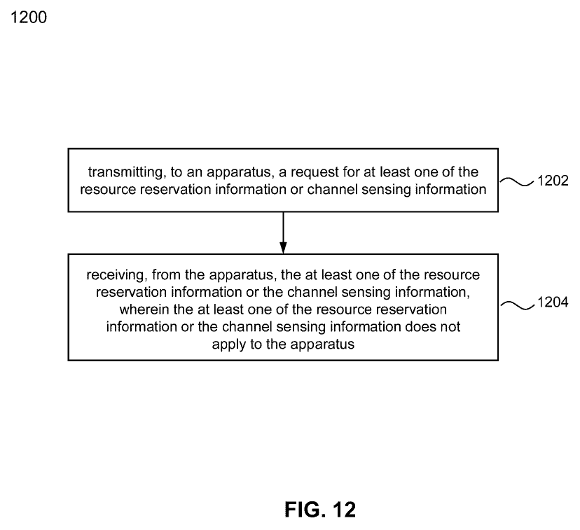

FIG. 12 is a schematic diagram illustrating a new first SL packet structure for a fair co-channel coexistence of a first sidelink communication and a second sidelink communication, consistent with some embodiments of the present disclosure. Referring to FIG. 12, a second SL packet is appended to a first SL packet to form the new first SL packet. In this example, the first SL packet is configured or preconfigured with 3 PSCCH symbols and 4 DMRS symbols without PSFCH, while the second SL packet is configured or preconfigured with PSCCH and PSSCH in adjacent PRBs. The packet structures for the first SL packet and the second SL packet are not limited to the ones shown in FIG. 12. Any packet structure can be used for the first SL packet.

For example, the first SL packet may include any other number of PSCCH symbols, DMRS symbols, and with or without PSFCH. The second SL packet may be configured or preconfigured with the second SL PSCCH and PSSCH in adjacent or non-adjacent PRBS.

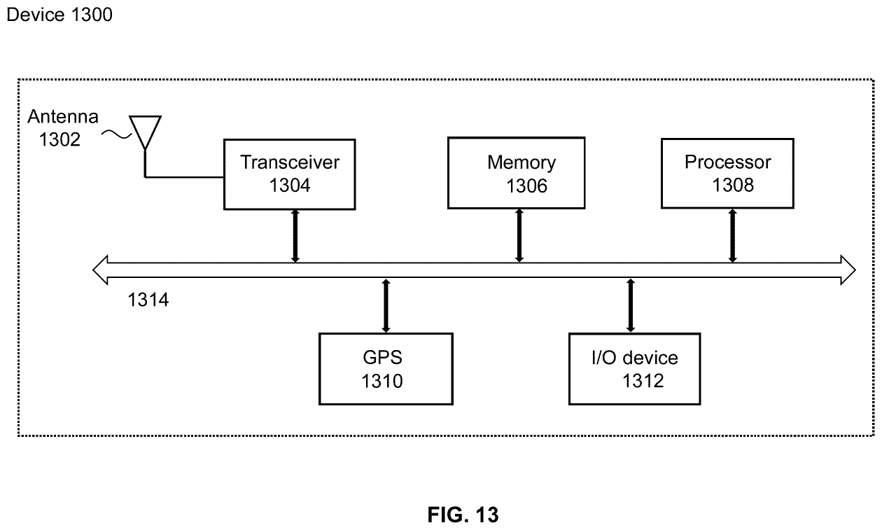

FIG. 13A is a schematic diagram illustrating a packet structure for a fair co-channel coexistence of a second sidelink communication and a third sidelink communication; FIG. 13B is a schematic diagram illustrating a packet structure for a fair co-channel coexistence of a first sidelink communication and the third sidelink communication; and FIG. 13C is a schematic diagram illustrating a packet structure for a fair co-channel coexistence of the first, second, and third sidelink communications, consistent with some embodiments of the present disclosure. Referring to FIG. 13A, a second SL packet is appended to a third SL packet to form a new third SL packet for a fair co-channel coexistence of the second sidelink communication and the third sidelink communication. Referring to FIG. 13B, a first SL packet is appended to a third SL packet to form a new third SL packet for a fair co-channel coexistence of the first sidelink communication and the third sidelink communication. Referring to FIG. 13C, a first SL packet and a second SL packet are appended to a third SL packet to form a new third SL packet for a fair co-channel coexistence of the first, second, and third sidelink communications.

In some embodiments, the first sidelink communication is NR SL, the second sidelink communication is LTE SL, and the third sidelink communication is a future SL (e.g., 6G, 7G, or any future generation). In these embodiments, for example, in FIG. 13A, an LTE PSCCH can be appended to a future SL packet (e.g., PSCCH, PSSCH, PSFCH for the future SL) to form a new future SL packet; in FIG. 13B, an NR PSCCH can be appended to a future SL packet to form a new future SL packet; and in FIG. 13C, both an LTE PSCCH and an NR PSCCH can be appended to a future SL packet to form a new future SL packet. In these embodiments, when an LTE SL device (e.g., a Type C device) receives the new future SL packet as shown in FIG. 13A or FIG. 13C, the LTE SL device can decode the LTE PSCCH part of the new future SL packet and obtain the resource reservation and priority of the future SL in the LTE SCI format by converting the future SCI format to the LTE SCI format. The LTE SL device then can take into account the received future SL resource reservation for the resource selection or reselection. Similarly, an NR SL device can decode the NR PSCCH part of the new future SL packet as shown in FIG. 13B or FIG. 13C and obtain the resource reservation and priority of the future SL in the NR SCI format. The NR SL device then can take into account the received future SL resource reservation for the resource selection or reselection. In this way, fairness in resource selection or reselection in a dynamic co-channel coexistence of LTE SL, NR SL, and/or future SL is achieved.

In some embodiments, a dynamic packet structure selection is applied to the future SL devices to reduce the overhead due to the LTE PSCCH and/or the NR PSCCH. The criteria used for determining whether or not to append the LTE PSCCH to the future SL packets are similar to that of the NR SL devices. The criteria for determining whether or not to append the NR PSCCH to the future SL packets can additionally include at least one of the following factors: (a) whether the future SL device transmits messages periodically (e.g., every 100 ms) using SPS and/or coexists with LTE SL devices only; (b) whether the LTE SL can avoid selecting resources that the future device uses based on sensing of a sidelink received signal strength indicator (S-RSSI) when the LTE control signal (e.g., LTE PSCCH) or data is not appended to the future SL packet; (c) whether the future device receives NR SL packets from NR SL devices for a detection time period, the detection time period being a configured or preconfigured time period; (d) whether detection of the NR SL packets is based on a NR SCI decoding result (successful or unsuccessful) and/or NR SL-RSRP (e.g., whether NR SL-RSRP is above a configured or preconfigured threshold or not, where the NR SL-RSRP threshold can be a function of NR SL priority and future SL priority); (e) whether a number of sub-channels that the future SL device uses is below a configured or preconfigured threshold number, or a sub-channel size that the future SL device uses is below a configured or preconfigured threshold size; (f) whether a latency requirement related to a transmission is higher than a configured or preconfigured threshold latency; (g) whether a battery level of the future SL device needs to reduce a transmission time due to need for power saving; or (h) whether there is no overlapping in time or frequency of two resource pools selected from an LTE SL resource pool, an NR SL resource pool, and a future SL resource pool.

In some embodiments, a cost factor associated with the overhead introduced by appending the LTE PSCCH and/or the NR PSCCH is introduced to control the overhead. The cost factor can be defined as the ratio between the number of resources for the future SL and the number of resources for the LTE PSCCH and/or the NR PSCCH. Alternatively, two cost factors can be defined: the first cost factor is the ratio between the number of resources for the future SL and the number of resources for LTE PSCCH; and the second cost factor is the ratio between the number of resources for the future SL and the number of resources for the NR PSCCH. If the cost is equal or above a (pre) configured cost factor, the UE may skip appending the LTE PSCCH and/or the NR PSCCH. Otherwise, the LTE PSCCH and/or the NR PSCCH is appended as acceptable overhead to the novel future SL packet structure.

FIG. 14 is a flow chart illustrating a method 1400 for a packet structure selection in sidelink communications, consistent with some embodiments of the present disclosure. The method 1400 may be performed by a UE in a sidelink communication.

The method 1400 includes a step 1402 of determining, by a first device, whether the device coexists with a second sidelink communication. In an embodiment, the first device is an NR SL device (e.g., a Type A or Type B device) used for NR SL, and the second sidelink communication is LTE SL. In this embodiment, the NR SL device determines whether the device coexists with an LTE SL communication. In another embodiment, the first device is a future SL device and the second sidelink communication is the NR SL or the LTE SL. The future SL device may include a module for the future sidelink communication, and at least one of a module for the NR SL and a module for the LTE SL.

The method 1400 may include a step 1404 of appending, by the first device, the second SL packet to the first SL packet, in response to a determination that the first device coexists with the second sidelink communication. The second SL packet may be a control signal or data for the second sidelink communication. In an embodiment, the first sidelink communication is an NR sidelink communication, the second sidelink communication is an LTE sidelink communication, and the control signal or data for the second sidelink communication is an LTE PSCCH that comprises a resource reservation and/or a priority of the NR sidelink in an LTE sidelink SCI format. In this embodiment, the packet for the first sidelink communication may include at least one of: an NR PSCCH, an NR PSSCH, or an NR PSFCH. In another embodiment, the first sidelink communication is a future sidelink communication, the second sidelink communication is an NR sidelink communication or an LTE sidelink communication, and the control signal or data for the second sidelink communication is at least one of: an NR PSCCH, an NR PSSCH, or an LTE PSCCH that comprises a resource reservation and/or a priority of the future sidelink communication in an NR SCI format or an LTE SCI format. The future sidelink communication may include at least one of a 6G sidelink communication or a 7G sidelink communication or any future generation sidelink communication.

The method 1400 may include a step 1406 of performing the resource selection or reselection based on one or more resource reservation constraints for the second sidelink communication. In some embodiments, the one or more resource reservation constraints for the second sidelink communication includes at least one of a time offset between a retransmission and an initial transmission, or an interval of SPS.

The method 1400 may include a step 1408 of deciding not to append the second SL packet to the first SL packet, in response to a determination that the first device does not coexist with the second sidelink communication. The second SL packet may be the control signal or data for the second sidelink communication. The deciding whether to append the control signal or data for the second sidelink communication to the packet for the first sidelink communication is based on at least one of: (a) whether the first device transmits messages periodically using SPS; (b) whether the second sidelink communication avoids Selecting resources that the first device uses based on sensing of a S-RSSI when the control signal or data for the second sidelink communication is not appended to the packet for the first sidelink communication; (c) whether the first device receives packets for the second sidelink communication from devices in the second sidelink communication for a detection time period, the detection time period being a configured or preconfigured time period; (d) whether detection of the packets for the second sidelink communication is based on a second sidelink communication SCI decoding result; (e) whether a number of sub-channels that the first device uses is below a configured or preconfigured threshold number, or a sub-channel size that the device uses is below a configured or preconfigured threshold size; (f) whether a latency requirement related to a transmission is higher than a configured or preconfigured threshold latency; (g) whether a battery level of the first device needs to reduce a transmission time due to need for power saving; or (h) whether there is no overlapping in time or frequency of a resource pool of the first sidelink communication and a resource pool of the second sidelink communication.

The method 1400 may include a step 1410 of performing the resource selection or reselection without the one or more resource reservation constraints for the second sidelink communication. In some embodiments, performing the resource selection or reselection without the one or more resource reservation constraints for the second sidelink communication further includes transmitting the first SL packet without appending a control signal or data for the second sidelink communication.

FIG. 15 is a schematic diagram illustrating a method for a packet structure selection for sidelink communications, consistent with some embodiments of the present disclosure. The method 1500 may be performed by a UE in a sidelink communication. For example, the method 1500 is performed by a first device in a first sidelink communication. In an embodiment, the first device is an NR SL device (e.g., a Type A or Type B device) used for NR SL, and the second sidelink communication is LTE SL. In another embodiment, the first device is a future device and the second sidelink communication is the NR SL or the LTE SL.

Referring to FIG. 15, the method 1500 includes a step 1502 of determining whether a dynamic packet structure selection is enabled for reducing overhead of a second sidelink communication packet. The second sidelink communication packet may be a control signal or data for the second sidelink communication. In some embodiments, determining whether the dynamic packet structure selection is enabled for reducing the overhead of the second sidelink communication packet is based on at least one of: (a) whether the first device transmits messages periodically using SPS; (b) whether the second sidelink communication avoids selecting resources that the first device uses based on sensing of a S-RSSI when the control signal or data for the second sidelink communication is not appended to the packet for the first sidelink communication; (c) whether the first device receives packets for the second sidelink communication from devices in the second sidelink communication for a detection time period, the detection time period being a configured or preconfigured parameter; (d) whether detection of the packets for the second sidelink communication is based on a second sidelink communication SCI decoding result; (e) whether a number of sub-channels that the first device uses is below a configured or preconfigured threshold number, or a sub-channel size that the first device uses is below a configured or preconfigured threshold size; (f) whether a latency requirement related to a transmission is higher than a configured or preconfigured threshold latency; (g) whether a battery level of the first device needs to reduce a transmission time due to need for power saving; or (h) whether there is no overlapping in time or frequency of two resource pools selected from a resource pool of the first sidelink communication, a resource pool of the second sidelink communication, and a resource pool of a third sidelink communication.

The method 1500 may include a step 1504 of appending the second sidelink communication packet to the first sidelink communication packet, in response to a determination that the dynamic packet structure selection is not enabled for reducing the overhead of the second sidelink communication packet.

The method 1500 may include a step 1506 of performing a resource selection or reselection based on one or more resource reservation constraints for the second sidelink communication.

The method 1500 may include a step 1508 of determining whether a condition is met for reducing the overhead of the second sidelink communication packet, in response to a determination that the dynamic packet structure selection is enabled for reducing the overhead of the second sidelink communication packet. In response to a determination that the condition is not met for reducing the overhead of the second sidelink communication packet, the method performs the step 1504 in which the second sidelink communication packet is appended to the first sidelink communication packet and the step 1506 of performing the resource selection or reselection based on one or more resource reservation constraints for the second sidelink communication.

The method 1500 may include a step 1510 of deciding not to append the second sidelink communication packet to the first sidelink communication packet, in response to a determination that the condition is met for reducing the overhead of the second sidelink communication packet.

The method 1500 may include a step 1512 of performing a resource selection or reselection without one or more resource reservation constraints for the second sidelink communication. In an embodiment, the first sidelink communication is a future sidelink communication, the second sidelink communication is an NR sidelink communication or an LTE sidelink communication, and the second sidelink communication packet is a control signal or data for the second sidelink communication that includes at least one of: an NR PSCCH, an NR PSSCH, or an LTE PSCCH. In another embodiment, the first sidelink communication is an NR sidelink communication, the second sidelink communication is an LTE sidelink communication, and the second sidelink communication packet is a control signal or data for the second sidelink communication that includes an LTE PSCCH.

FIG. 16 is a schematic diagram illustrating a method for a packet structure selection in sidelink communications, consistent with some embodiments of the present disclosure. The method 1600 may be performed by a UE in a sidelink communication.

Referring to FIG. 16, the method 1600 includes a step 1602 of determining whether a third SL device coexists with a first sidelink communication and a second sidelink communication. The third SL device may be a UE in a third sidelink communication. In an embodiment, the third sidelink communication is a future sidelink communication, the first sidelink communication is an NR sidelink communication, and the second sidelink communication is an LTE sidelink communication.

The method 1600 may include a step 1604 of appending a first sidelink communication packet and the second sidelink communication packet to the third sidelink communication packet, in response to a determination that the third SL device coexists with the first and second sidelink communications. The first sidelink communication packet may be a control signal or data for the first sidelink communication and the second sidelink communication packet may be a control signal or data for the second sidelink communication. In an embodiment, the control signal or data for the first sidelink communication is at least one of a PSCCH or a PSSCH of the first sidelink communication; and the control signal or data for the second sidelink communication is at least one of a PSCCH or a PSSCH of the second sidelink communication. In some embodiments, appending the first sidelink communication packet and the second sidelink communication packet to the third sidelink communication packet is based on at least one of: (a) whether the third SL device transmits messages periodically using SPS and coexists with the second sidelink communication; (b) whether the second sidelink communication avoids selecting resources that the device uses based on S-RSSI sensing when the control signal or data for the second sidelink communication is not appended to the packet for the first sidelink communication; (c) whether the device receives packets for at least one of: the first sidelink communication from devices in the first sidelink communication for a first detection time period, or the second sidelink communication from devices in the second sidelink communication for a second detection time period, the first and second detection time periods being a configured or preconfigured parameter; (e) whether a number of sub-channels that the third SL device uses is below a configured or preconfigured threshold number, or a sub-channel size that the device uses is below a configured or preconfigured threshold size; (f) whether a latency requirement related to a transmission is higher than a configured or preconfigured threshold latency; (g) whether a battery level of the third SL device needs to reduce a transmission time due to need for power saving; or (h) whether there is no overlapping in time or frequency of two or more resource pools selected from a resource pool of the first sidelink communication, a resource pool of the second sidelink communication, and a resource pool of the third sidelink communication.

The method 1600 may include a step 1606 of performing a resource selection or reselection based on one or more resource reservation constraints for at least one of the first sidelink communication or the second sidelink communication.

The method 1600 may include a step 1608 of determining whether the third SL device coexists with the first sidelink communication only, in response to a determination that the third SL device does not coexist with both the first sidelink communication and the second sidelink communication.

The method 1600 may include a step 1610 of appending only the first sidelink communication packet to the third sidelink communication packet, in response to a determination that the third SL device coexists with the first sidelink communication only. The first sidelink communication packet may be a control signal or data for the first sidelink communication.

The method 1600 may include a step 1612 of performing a resource selection or reselection based on one or more resource reservation constraints for the first sidelink communication.

The method 1600 may include a step 1614 of determining whether the device coexists with the second sidelink communication only, in response to a determination that the device does not coexist with the first sidelink communication only.

The method 1600 may include a step 1616 of appending the second sidelink communication packet to the third sidelink communication packet, in response to a determination that the third SL device coexists with the second sidelink communication only. The second sidelink communication packet may be a control signal or data for the second sidelink communication.

The method 1600 may include a step 1618 of performing a resource selection or reselection based on one or more resource reservation constraints for the second sidelink communication.

The method 1600 may include a step 1620 of deciding not to append the first sidelink communication packet or the second sidelink communication packet to the third sidelink communication packet, in response to a determination that the device does not coexist with the second sidelink communication only. The first sidelink communication packet may be a control signal or data for the first sidelink communication, and the second sidelink communication packet may be a control signal or data for the second sidelink communication.

The method 1600 may include a step 1622 of performing a resource selection or reselection without resource reservation constraints for the first sidelink communication and/or resource reservation constraints for the second sidelink communication.

FIG. 17 is a block diagram of a UE 1700, consistent with some embodiments of the present disclosure. The UE 1700 can be a Type A, Type B, Type C, or any other type of UE. UE 1700 may be mounted in a moving vehicle or in a fixed position. UE 1700 may take any form, including but not limited to, a vehicle, a component mounted in a vehicle, a road-side unit, a laptop computer, a wireless terminal including a mobile phone, a wireless handheld device, or wireless personal device, or any other form. Referring to FIG. 17, the UE 1700 may include antenna 1702 that may be used for transmission or reception of electromagnetic signals to/from a base station or other UEs. The Antenna 1702 may include one or more antenna elements and may enable different input-output antenna configurations, for example, multiple input multiple output (MIMO) configuration, multiple input single output (MISO) configuration, and single input multiple output (SIMO) configuration. In some embodiments, the antenna 1702 may include multiple (e.g., tens or hundreds) antenna elements and may enable multi-antenna functions such as beamforming. In some embodiments, the antenna 1702 is a single antenna.

The UE 1700 may include a transceiver 1704 that is coupled to the antenna 1702. The transceiver 1704 may be a wireless transceiver at the UE 1700 and may communicate bi-directionally with a base station or other UEs. For example, the transceiver 1704 may receive/transmit wireless signals from/to a base station via downlink/uplink communication. The transceiver 1704 may also receive/transmit wireless signals from/to another UE or RSU via sidelink communication. The transceiver 1704 may include a modem to modulate the packets and provide the modulated packets to the antenna 1702 for transmission, and to demodulate packets received from the antenna 1702.

The UE 1700 may include a memory 1706. The memory 1706 may be any type of computer-readable storage medium including volatile or non-volatile memory devices, or a combination thereof. The computer-readable storage medium includes, but is not limited to, non-transitory computer storage media. A non-transitory storage medium may be accessed by a general purpose or special purpose computer. Examples of non-transitory storage medium include, but are not limited to, a portable computer diskette, a hard disk, random access memory (RAM), read-only memory (ROM), an erasable programmable read-only memory (EPROM), electrically erasable programmable ROM (EEPROM), a digital versatile disk (DVD), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable medium.

The memory 1706 may store information related to identities of device 1700 and the signals and/or data received by antenna 1702. The memory 1706 may also store post-processing signals and/or data. The memory 1706 may also store computer-readable program instructions, mathematical models, and algorithms that are used in signal processing in transceiver 1704 and computations in processor 1708. The memory 1706 may further store computer-readable program instructions for execution by processor 1708 to operate UE 1700 to perform various functions described in this disclosure. In some examples, the memory 1706 may include a basic input/output system (BIOS) which may control basic hardware or software operation such as the interaction with peripheral components or devices. In some embodiments, the UE 1700 is a Type A UE and the memory 1706 includes both LTE SL and NR SL modules. In some embodiments, the UE 1700 is a Type B UE and the memory 1706 includes an NR SL module only. In some embodiments, the UE 1700 is a Type C UE and the memory 1706 includes an LTE SL module only.

The computer-readable program instructions of the present disclosure may be assembler instructions, instruction-set-architecture (ISA) instructions, machine instructions, machine-dependent instructions, microcode, firmware instructions, state-setting data, or source code or object code written in any combination of one or more programming languages, including an object-oriented programming language, and conventional procedural programming languages. The computer-readable program instructions may execute entirely on a computing device as a stand-alone software package, or partly on a first computing device and partly on a second computing device remote from the first computing device. In the latter scenario, the second, remote computing device may be connected to the first computing device through any type of network, including a local area network (LAN) or a wide area network (WAN).

The UE 1700 may include a processor 1708 that may include a hardware device with processing capabilities. The processor 1708 may include at least one of a general-purpose processor, a digital signal processor (DSP), a central processing unit (CPU), a microcontroller, an application specific integrated circuit (ASIC), a field programmable gate array (FPGA), a programmable logic device, a discrete gate or transistor logic component, a discrete hardware component, or other programmable logic device. Examples of the general-purpose processor include, but are not limited to, a microprocessor, any conventional processor, a controller, a microcontroller, or a state machine. In some embodiments, the processor 1708 may be implemented using a combination of devices (e.g., a combination of a DSP and a microprocessor, multiple microprocessors, one or more microprocessors in conjunction with a DSP core, or any other such configuration). The processor 1708 may receive, from transceiver 1704, downlink signals or sidelink signals and further process the signals. The processor 1708 may also receive, from transceiver 1704, data packets and further process the packets. In some embodiments, the processor 1708 may be configured to operate a memory using a memory controller. In some embodiments, a memory controller may be integrated into the processor 1708. The processor 1708 may be configured to execute computer-readable instructions stored in a memory (e.g., the memory 1706) to cause the UE 1700 to perform various functions.

The UE 1700 may include a global positioning system (GPS) 1710. The GPS 1710 may be used for enabling location-based services or other services based on a geographical position of the UE 1700 and/or for synchronization among UEs. The GPS 1710 may receive global navigation satellite systems (GNSS) signals from a single satellite or a plurality of satellite signals via the antenna 1702 and provide a geographical position of the UE 1700 (e.g., coordinates of the UE 1700).

The UE 1700 may include an input/output (I/O) device 1712 that may be used to communicate a result of signal processing and computation to a user or another device. The I/O device 1712 may include a user interface including a display and an input device to transmit a user command to processor 1708. The display may be configured to display a status of signal reception at the UE 1700, the data stored at memory 1706, a status of signal processing, and a result of computation, etc. The display may include, but is not limited to, a cathode ray tube (CRT), a liquid crystal display (LCD), a light-emitting diode (LED), a gas plasma display, a touch screen, or other image projection devices for displaying information to a user. The input device may be any type of computer hardware equipment used to receive data and control signals from a user. The input device may include, but is not limited to, a keyboard, a mouse, a scanner, a digital camera, a joystick, a trackball, cursor direction keys, a touchscreen monitor, or audio/video commanders, etc.

The UE 1700 may further include a machine interface 1714, such as an electrical bus that connects the transceiver 1704, the memory 1706, the processor 1708, the GPS 1710, and the I/O device 1712.

In some embodiments, the UE 1700 may be configured to or programmed for sidelink communications. For example, the UE 1700 may be a UE in a first sidelink communication, and the processor 1708 may be configured to execute the instructions stored in the memory 1706 to determine whether the UE 1700 coexists with a second sidelink communication; decide whether to append control signal or data for the second sidelink communication to a packet for the first sidelink communication based on a result of the determining; and perform a resource selection or reselection based on a result of the deciding. In another embodiment, the processor 1708 may be configured to execute the instructions to determine whether a dynamic packet structure selection is enabled for reducing a control signal or data overhead for a second sidelink communication; and append, in response to a determination that the dynamic packet structure selection is not enabled for reducing the control signal or data overhead for the second sidelink communication, a control signal or data for the second sidelink communication to a packet for the first sidelink communication. In another embodiment, the UE 1700 may be a UE in a third sidelink communication and the processor 1708 may be configured to execute the instructions to determine whether the UE 1700 coexists with a first sidelink communication and a second sidelink communication; and decide, based on a result of the determining, whether to append at least one of: a control signal or data for the first sidelink communication, or a control signal or data for the second sidelink communication, to a packet for the third sidelink communication.

As used in this disclosure, use of the term “or” in a list of items indicates an inclusive list. The list of items may be prefaced by a phrase such as “at least one of’ or “one or more of’. For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification the terms “comprise”, “include” or “contain” may be used interchangeably and have the same meaning and are to be construed as inclusive and open-ended. The terms “comprise”, “include” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

The flowcharts and block diagrams in the figures illustrate examples of the architecture, functionality, and operation of possible implementations of systems, methods, and devices according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

It is understood that the described embodiments are not mutually exclusive, and elements, components, materials, or steps described in connection with one example embodiment may be combined with, or eliminated from, other embodiments in suitable ways to accomplish desired design objectives.

Reference herein to “some embodiments” or “some exemplary embodiments” means that a particular feature, structure, or characteristic described in connection with the embodiment can be included in at least one embodiment. The appearance of the phrases “one embodiment” “some embodiments” or “another embodiment” in various places in the present disclosure do not all necessarily refer to the same embodiment, nor are separate or alternative embodiments necessarily mutually exclusive of other embodiments.

Additionally, the articles “a” and “an” as used in the present disclosure and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable subcombination or as suitable in any other described embodiment of the specification. Certain features described in the context of various embodiments are not essential features of those embodiments, unless noted as such.

It will be further understood that various modifications, alternatives and variations in the details, materials, and arrangements of the parts which have been described and illustrated in order to explain the nature of described embodiments may be made by those skilled in the art without departing from the scope. Accordingly, the following claims embrace all such alternatives, modifications and variations that fall within the terms of the claims.
Clause 1. A method for a packet structure selection for a device in a first sidelink communication, the method comprising:
determining, by the device, whether the device coexists with a second sidelink communication;
deciding, by the device, whether to append a control signal or data for the second sidelink communication to a packet for the first sidelink communication based on a result of the determining; and
performing, by the device, a resource selection or reselection based on a result of the deciding.
Clause 2. The method of Clause 1, wherein deciding whether to append the control signal or data for the second sidelink communication to the packet for the first sidelink communication based on a result of the determining and performing the resource selection or reselection based on the result of the deciding further comprises:
in response to a determination that the device coexists with the second sidelink communication,
appending the control signal or data for the second sidelink communication to the packet for the first sidelink communication, and
performing the resource selection or reselection based on one or more resource reservation constraints for the second sidelink communication; and
in response to a determination that the device does not coexist with the second sidelink communication,
deciding not to append the control signal or data for the second sidelink communication to the packet for the first sidelink communication, and
performing the resource selection or reselection without the one or more resource reservation constraints for the second sidelink communication.
Clause 3. The method of Clause 1, wherein the first sidelink communication is a new radio (NR) sidelink communication, the second sidelink communication is a long-term evolution (LTE) sidelink communication, and the control signal or data for the second sidelink communication is an LTE physical sidelink control channel (PSCCH) that comprises a resource reservation and a priority of the NR sidelink communication in an LTE sidelink control information (SCI) format.
Clause 4. The method of Clause 3, wherein the packet for the first sidelink communication comprises at least one of NR physical sidelink control channel (PSCCH), NR physical sidelink shared channel (PSSCH), or NR physical sidelink feedback channel (PSFCH).
Clause 5. The method of Clause 1, wherein the first sidelink communication is a future sidelink communication, the second sidelink communication is an NR sidelink communication or an LTE sidelink communication, and the control signal or data for the second sidelink communication is at least one of an NR PSCCH, an NR PSSCH, or an LTE PSCCH that comprises a resource reservation and a priority of the future sidelink communication in an NR SCI format or an LTE SCI format.
Clause 6. The method of Clause 5, wherein the future sidelink communication comprises at least one of a sixth generation (6G) sidelink communication or a seventh generation (7G) sidelink communication.
Clause 7. The method of Clause 2, wherein the one or more resource reservation constraints for the second sidelink communication comprise at least one of a time offset between a retransmission and an initial transmission, or an interval of semi-persistent scheduling (SPS).
Clause 8. The method of Clause 1, wherein deciding whether to append the control signal or data for the second sidelink communication to the packet for the first sidelink communication is further based on at least one of:
(a) whether the device transmits messages periodically using SPS;
(b) whether the second sidelink communication avoids selecting resources that the device uses based on sensing of a sidelink received signal strength indicator (S-RSSI) when the control signal or data for the second sidelink communication is not appended to the packet for the first sidelink communication;
(c) whether the device receives packets for the second sidelink communication from devices in the second sidelink communication for a detection time period, the detection time period being a configured or preconfigured time period;
(d) whether detection of the packets for the second sidelink communication is based on a second sidelink communication SCI decoding result;
(e) whether a number of sub-channels that the device uses is below a configured or preconfigured threshold number, or a sub-channel size that the device uses is below a configured or preconfigured threshold size;
(f) whether a latency requirement related to a transmission is higher than a configured or preconfigured threshold latency;
(g) whether a battery level of the device needs to reduce a transmission time due to need for power saving; or
(h) whether there is no overlapping in time or frequency of a resource pool of the first sidelink communication and a resource pool of the second sidelink communication.
Clause 9. The method of Clause 2, further comprising:
transmitting the packet with or without the appended control signal or data for the second sidelink communication.
Clause 10. A method for a packet structure selection for a device in a first sidelink communication, the method comprising:
determining, by the device, whether a dynamic packet structure selection is enabled for reducing a control signal or data overhead for a second sidelink communication; and
appending, in response to a determination that the dynamic packet structure selection is not enabled for reducing the control signal or data overhead for the second sidelink communication, a control signal or data for the second sidelink communication to a packet for the first sidelink communication.
Clause 11. The method of Clause 10, further comprising:
performing a resource selection or reselection based on one or more resource reservation constraints for the second sidelink communication.
Clause 12. The method of Clause 10, further comprising:
determining, in response to a determination that the dynamic packet structure selection is enabled for reducing the control signal or data overhead for the second sidelink communication, whether a condition is met for reducing a control signal or data overhead for the second sidelink communication.
Clause 13. The method of Clause 12, further comprising:
appending, in response to a determination that the condition is not met for reducing a control signal or data overhead for the second sidelink communication, the control signal or data for the second sidelink communication to the packet for the first sidelink communication.
Clause 14. The method of Clause 13, further comprising:
performing a resource selection or reselection based on one or more resource reservation constraints for the second sidelink communication.
Clause 15. The method of Clause 12, further comprising:
deciding, in response to a determination that the condition is met for reducing a control signal or data overhead for the second sidelink communication, not to append the control signal or data for the second sidelink communication to the packet for the first sidelink communication.
Clause 16. The method of Clause 15, further comprising:
performing a resource selection or reselection without one or more resource reservation constraints for the second sidelink communication.
Clause 17. The method of Clause 10, wherein the first sidelink communication is a future sidelink communication, the second sidelink communication is an NR sidelink communication or an LTE sidelink communication, and the control signal or data for the second sidelink communication is at least one of an NR PSCCH, an NR PSSCH, or an LTE PSCCH.
Clause 18. The method of Clause 10, wherein the first sidelink communication is an NR sidelink communication, the second sidelink communication is an LTE sidelink communication, and the control signal or data for the second sidelink communication is an LTE PSCCH.
Clause 19. The method of Clause 10, wherein determining whether the dynamic packet structure selection is enabled for reducing the control signal or data overhead for the second sidelink communication is based on at least one of:
(a) whether the device transmits messages periodically using SPS;
(b) whether the second sidelink communication avoids selecting resources that the device uses based on sensing of a sidelink received signal strength indicator (S-RSSI) when the control signal or data for the second sidelink communication is not appended to the packet for the first sidelink communication;
(c) whether the device receives packets for the second sidelink communication from devices in the second sidelink communication for a detection time period, the detection time period being a configured or preconfigured parameter;
(d) whether detection of the packets for the second sidelink communication is based on a second sidelink communication SCI decoding result;
(e) whether a number of sub-channels that the device uses is below a configured or preconfigured threshold number, or a sub-channel size that the device uses is below a configured or preconfigured threshold size;
(f) whether a latency requirement related to a transmission is higher than a configured or preconfigured threshold latency;
(g) whether a battery level of the device needs to reduce a transmission time due to need for power saving; or
(h) whether there is no overlapping in time or frequency of two resource pools selected from a resource pool of the first sidelink communication, a resource pool of the second sidelink communication, and a resource pool of a third sidelink communication.
Clause 20. A method for a packet structure selection for a device in a first sidelink communication, the method comprising:
determining, by the device, whether the device coexists with a second sidelink communication and a third sidelink communication; and
deciding, based on a result of the determining, whether to append at least one of: a control signal or data for the second sidelink communication, or a control signal or data for the third sidelink communication, to a packet for the first sidelink communication.
Clause 21. The method of Clause 20, further comprising:
appending, in response to a determination that the device coexists with the second sidelink communication and the third sidelink communication, the control signal or data for the second sidelink communication and the control signal or data for the third sidelink communication to the packet for the first sidelink communication.
Clause 22. The method of Clause 21, further comprising:
performing a resource selection or reselection based on one or more resource reservation constraints for at least one of the second sidelink communication or the third sidelink communication.
Clause 23. The method of Clause 20, further comprising:
determining, in response to a determination that the device does not coexist with both the second sidelink communication and the third sidelink communication, whether the device coexists with the second sidelink communication only; and
appending, in response to a determination that the device coexists with the second sidelink communication only, the control signal or data for the second sidelink communication to the packet for the first sidelink communication.
Clause 24. The method of Clause 23, further comprising:
performing a resource selection or reselection based on one or more resource reservation constraints for the second sidelink communication.
Clause 25. The method of Clause 23, further comprising:
determining, in response to a determination that the device does not coexist with the second sidelink communication only, whether the device coexists with the third sidelink communication only; and
appending, in response to a determination that the device coexists with the third sidelink communication only, the control signal or data for the third sidelink communication to the packet for the first sidelink communication.
Clause 26. The method of Clause 25, further comprising:
performing a resource selection or reselection based on one or more resource reservation constraints for the third sidelink communication.
Clause 27. The method of Clause 25, further comprising:
deciding, in response to a determination that the device does not coexist with the third sidelink communication only, not to append the control signal or data for the second sidelink communication or the control signal or data for the third sidelink communication to the packet for the first sidelink communication.
Clause 28. The method of Clause 20, wherein the first sidelink communication is a future sidelink communication, the second sidelink communication is an NR sidelink communication, and the third sidelink communication is an LTE sidelink communication.
Clause 29. The method of Clause 20, wherein the control signal or data for the second sidelink communication or the control signal or data for the third sidelink communication is at least one of a physical sidelink control channel (PSCCH) or a physical sidelink shared channel (PSSCH).
Clause 30. The method of Clause 20, wherein deciding whether to append the control signal or data for the second sidelink communication and the control signal or data for the third sidelink communication to the packet for the first sidelink communication is further based on at least one of:
(a) whether the device transmits messages periodically using semi-persistent scheduling (SPS) and coexists with the third sidelink communication;
(b) whether the third sidelink communication avoids selecting resources that the device uses based on S-RSSI sensing when the control signal or data for the third sidelink communication is not appended to the packet for the first sidelink communication;
(c) whether the device receives packets for at least one of: the second sidelink communication from devices in the second sidelink communication for a first detection time period, or the third sidelink communication from devices in the third sidelink communication for a second detection time period, the first and second detection time periods being a configured or preconfigured parameter;
(d) whether a number of sub-channels that the device uses is below a configured or preconfigured threshold number, or a sub-channel size that the device uses is below a configured or preconfigured threshold size;
(e) whether a latency requirement related to a transmission is higher than a configured or preconfigured threshold latency;
(f) whether a battery level of the device needs to reduce a transmission time due to need for power saving; or
(g) whether there is no overlapping in time or frequency of two or more resource pools selected from a resource pool of the first sidelink communication, a resource pool of the second sidelink communication, and a resource pool of the third sidelink communication.
Clause 31. A device for a first sidelink communication, the device comprising:
a memory storing an instruction; and
a processor configured to execute the instruction stored in the memory to:
determine whether the device coexists with a second sidelink communication;
decide whether to append control signal or data for the second sidelink communication to a packet for the first sidelink communication based on a result of the determining; and
perform a resource selection or reselection based on a result of the deciding.
Clause 32. The device of Clause 31, wherein the processor is configured to execute the instruction stored in the memory to:
in response to a determination that the device coexists with the second sidelink communication,
append the control signal or data for the second sidelink communication to the packet for the first sidelink communication, and
perform the resource selection or reselection based on one or more resource reservation constraints for the second sidelink communication; and
in response to a determination that the device does not coexist with the second sidelink communication,
decide not to append the control signal or data for the second sidelink communication to the packet for the first sidelink communication, and
perform the resource selection or reselection without the one or more resource reservation constraints for the second sidelink communication.
Clause 33. The device of Clause 31, wherein the first sidelink communication is a new radio (NR) sidelink communication, the second sidelink communication is a long-term evolution (LTE) sidelink communication, and the control signal or data for the second sidelink communication is an LTE physical sidelink control channel (PSCCH) that comprises a resource reservation and a priority of the NR sidelink communication in an LTE sidelink control information (SCI) format.
Clause 34. The device of Clause 33, wherein the packet for the first sidelink communication comprises at least one of NR physical sidelink control channel (PSCCH), NR physical sidelink shared channel (PSSCH), or NR physical sidelink feedback channel (PSFCH).
Clause 35. The device of Clause 31, wherein the first sidelink communication is a future sidelink communication, the second sidelink communication is an NR sidelink communication or an LTE sidelink communication, and the control signal or data for the second sidelink communication is at least one of an NR PSCCH, NR PSSCH, or an LTE PSCCH that comprises a resource reservation and a priority of the future sidelink communication in an NR SCI format or an LTE SCI format.
Clause 36. The device of Clause 34, wherein the future sidelink communication comprises at least one of a sixth generation (6G) sidelink communication or a seventh generation (7G) sidelink communication.
Clause 37. The device of Clause 32, wherein the one or more resource reservation constraints for the second sidelink communication comprise at least one of a time offset between a retransmission and an initial transmission, or an interval of semi-persistent scheduling (SPS).
Clause 38. The device of Clause 31, wherein deciding whether to append the control signal or data for the second sidelink communication to the packet for the first sidelink communication is further based on at least one of:
(a) whether the device transmits messages periodically using SPS;
(b) whether the second sidelink communication avoids selecting resources that the device uses based on sensing of a sidelink received signal strength indicator (S-RSSI) when the control signal or data for the second sidelink communication is not appended to the packet for the first sidelink communication;
(c) whether the device receives packets for the second sidelink communication from devices in the second sidelink communication for a detection time period, the detection time period being a configured or preconfigured time period;
(d) whether detection of the packets for the second sidelink communication is based on a second sidelink communication SCI decoding result;
(e) whether a number of sub-channels that the device uses is below a configured or preconfigured threshold number, or a sub-channel size that the device uses is below a configured or preconfigured threshold size;
(f) whether a latency requirement related to a transmission is higher than a configured or preconfigured threshold latency;
(g) whether a battery level of the device needs to reduce a transmission time due to need for power saving; or
(h) whether there is no overlapping in time or frequency of a resource pool of the first sidelink communication and a resource pool of the second sidelink communication.
Clause 39. The device of Clause 31, wherein the processor is configured to execute the instruction stored in the memory to:
transmit the packet with or without the appended control signal or data for the second sidelink communication.
Clause 40. A device for a first sidelink communication, the device comprising:
a memory storing an instruction; and
a processor configured to execute the instruction stored in the memory to:
determine whether a dynamic packet structure selection is enabled for reducing a control signal or data overhead for a second sidelink communication; and
append, in response to a determination that the dynamic packet structure selection is not enabled for reducing the control signal or data overhead for the second sidelink communication, a control signal or data for the second sidelink communication to a packet for the first sidelink communication.
Clause 41. The device of Clause 40, wherein the processor is configured to execute the instruction stored in the memory to:
perform a resource selection or reselection based on one or more resource reservation constraints for the second sidelink communication.
Clause 42. The device of Clause 40, wherein the processor is configured to execute the instruction stored in the memory to:
determine, in response to a determination that the dynamic packet structure selection is enabled for reducing the control signal or data overhead for the second sidelink communication, whether a condition is met for reducing a control signal or data overhead for the second sidelink communication.
Clause 43. The device of Clause 42, wherein the processor is configured to execute the instruction stored in the memory to:
append, in response to a determination that the condition is not met for reducing a control signal or data overhead for the second sidelink communication, the control signal or data for the second sidelink communication to the packet for the first sidelink communication.
Clause 44. The device of Clause 43, wherein the processor is configured to execute the instruction stored in the memory to:
perform a resource selection or reselection based on one or more resource reservation constraints for the second sidelink communication.
Clause 45. The device of Clause 42, wherein the processor is configured to execute the instruction stored in the memory to:
decide, in response to a determination that the condition is met for reducing a control signal or data overhead for the second sidelink communication, not to append the second sidelink communication control signal or data to the packet for the first sidelink communication.
Clause 46. The device of Clause 45, wherein the processor is configured to execute the instruction stored in the memory to:
perform a resource selection or reselection without one or more resource reservation constraints for the second sidelink communication.
Clause 47. The device of Clause 40, wherein the first sidelink communication is a future sidelink communication, the second sidelink communication is an NR sidelink communication or an LTE sidelink communication, and the control signal or data for the second sidelink communication is at least one of an NR PSCCH, NR PSSCH, or an LTE PSCCH.
Clause 48. The device of Clause 40, wherein the first sidelink communication is an NR sidelink communication, the second sidelink communication is an LTE sidelink communication, and the control signal or data for the second sidelink communication is an LTE PSCCH.
Clause 49. The device of Clause 40, wherein determining whether the dynamic packet structure selection is enabled for reducing the control signal or data overhead for the second sidelink communication is based on at least one of:
whether the device transmits messages periodically using SPS;

(a) whether the second sidelink communication avoids selecting resources that the device uses based on sensing of a sidelink received signal strength indicator (S-RSSI) when the control signal or data for the second sidelink communication is not appended to the packet for the first sidelink communication;

(b) whether the device receives packets for the second sidelink communication from devices in the second sidelink communication for a detection time period, the detection time period being a configured or preconfigured parameter;
(c) whether detection of the packets for the second sidelink communication is based on a second sidelink communication SCI decoding result;
(d) whether a number of sub-channels that the device uses is below a configured or preconfigured threshold number, or a sub-channel size that the device uses is below a configured or preconfigured threshold size;
(e) whether a latency requirement related to a transmission is higher than a configured or preconfigured threshold latency;
(f) whether a battery level of the device needs to reduce a transmission time due to need for power saving; or
(g) whether there is no overlapping in time or frequency of two resource pools selected from a resource pool of the first sidelink communication, a resource pool of the second sidelink communication, and a resource pool of a third t sidelink communication.
Clause 50. A device for a first sidelink communication, the device comprising:
a memory storing an instruction; and
a processor configured to execute the instruction stored in the memory to:
determine whether the device coexists with a second sidelink communication and a third sidelink communication; and
decide, based on a result of the determining, whether to append at least one of: a control signal or data for the second sidelink communication, or a control signal or data for the third sidelink communication, to a packet for the first sidelink communication.
Clause 51. The device of Clause 50, wherein the processor is configured to execute the instruction stored in the memory to:
append, in response to a determination that the device coexists with the second sidelink communication and the third sidelink communication, the control signal or data for the second sidelink communication and the control signal or data for the third sidelink communication to the packet for the first sidelink communication.
Clause 52. The device of Clause 51, wherein the processor is configured to execute the instruction stored in the memory to:
perform a resource selection or reselection based on one or more resource reservation constraints for at least one of the second sidelink communication or the third sidelink communication.
Clause 53. The device of Clause 50, wherein the processor is configured to execute the instruction stored in the memory to:
determine, in response to a determination that the device does not coexist with both the second sidelink communication and the third sidelink communication, whether the device coexists with the second sidelink communication only; and
append, in response to a determination that the device coexists with the second sidelink communication only, the control signal or data for the second sidelink communication to the packet for the first sidelink communication.
Clause 54. The device of Clause 53, wherein the processor is configured to execute the instruction stored in the memory to: perform a resource selection or reselection based on one or more
resource reservation constraints for the second sidelink communication.
Clause 55. The device of Clause 53, wherein the processor is configured to execute the instruction stored in the memory to:
determine, in response to a determination that the device does not coexist with the second sidelink communication only, whether the device coexists with the third sidelink communication only; and
append, in response to a determination that the device coexists with the third sidelink communication only, the control signal or data for the third sidelink communication to the packet for the first sidelink communication.
Clause 56. The device of Clause 55, wherein the processor is configured to execute the instruction stored in the memory to:
perform a resource selection or reselection based on one or more resource reservation constraints for the third sidelink communication.
Clause 57. The device of Clause 55, wherein the processor is configured to execute the instruction stored in the memory to:
decide, in response to a determination that the device does not coexist with the third sidelink communication only, not to append the control signal or data for the second sidelink communication or the control signal or data for the third sidelink communication to the packet for the first sidelink communication.
Clause 58. The device of Clause 50, wherein the first sidelink communication is a future sidelink communication, the second sidelink communication is an NR sidelink communication, and the third sidelink communication is an LTE sidelink communication.
Clause 59. The device of Clause 50, wherein the control signal or data for the second sidelink communication or the control signal or data for the third sidelink communication is at least one of a physical sidelink control channel (PSCCH) or a physical sidelink shared channel (PSSCH).
Clause 60. The device of Clause 50, wherein deciding whether to append the control signal or data for the second sidelink communication and the control signal or data for the third sidelink communication to the packet for the first sidelink communication is further based on at least one of:
(a) whether the device transmits messages periodically using semi-persistent scheduling (SPS) and coexists with the third sidelink communication;
(b) whether the third sidelink communication avoids selecting resources that the device uses based on S-RSSI sensing when the control signal or data for the third sidelink communication is not appended to the packet for the first sidelink communication;
(c) whether the device receives packets for at least one of: the second sidelink communication from devices in the second sidelink communication for a first detection time period, or the third sidelink communication from devices in the third sidelink communication for a second detection time period, the first and second detection time periods being a configured or preconfigured parameter;
(d) whether a number of sub-channels that the device uses is below a configured or preconfigured threshold number, or a sub-channel size that the device uses is below a configured or preconfigured threshold size;
(e) whether a latency requirement related to a transmission is higher than a configured or preconfigured threshold latency;
(f) whether a battery level of the device needs to reduce a transmission time due to need for power saving; or
(g) whether there is no overlapping in time or frequency of two or more resource pools selected from a resource pool of the first sidelink communication, a resource pool of the second sidelink communication, and a resource pool of the third sidelink communication.
Clause 61. A non-transitory computer-readable medium storing instructions that are executable by one or more processors of device for a first sidelink communication to perform a method, the method comprising:
determining whether the device coexists with a second sidelink communication;
deciding whether to append a control signal or data for the second sidelink communication to a packet for the first sidelink communication based on a result of the determining; and
performing a resource selection or reselection based on a result of the deciding.
Clause 62. A non-transitory computer-readable medium storing instructions that are executable by one or more processors of a device for a first sidelink communication to perform a method, the method comprising:
determining, by the device, whether a dynamic packet structure selection is enabled for reducing a control signal or data overhead for a second sidelink communication; and
appending, in response to a determination that the dynamic packet structure selection is not enabled for reducing a control signal or data overhead for a second sidelink communication, a control signal or data for the second sidelink communication to a packet for the first sidelink communication.
Clause 63. A non-transitory computer-readable medium storing instructions that are executable by one or more processors of a device for first sidelink communication to perform a method, the method comprising:
determining whether the device coexists with a second sidelink communication and a third sidelink communication; and
deciding, based on a result of the determining, whether to append at least one of: a control signal or data for the second sidelink communication, or a control signal or data for the third sidelink communication, to a packet for the first sidelink communication.

1. An apparatus for forwarding at least one of resource reservation information or channel sensing information in a sidelink communication, the apparatus comprising:
a memory storing an instruction; and
a processor configured to execute the instruction stored in the memory to:
receive, from at least one first user equipment (UE), the at least one of the resource reservation information or the channel sensing information, obtained by the at least one first UE;
store the at least one of the resource reservation information or the channel sensing information; and
transmit, to a second UE, the received at least one of the resource reservation information or the channel sensing information.

2. The apparatus of claim 1, wherein the processor is further configured to execute the instruction stored in the memory to:
receive a request for the at least one of the resource reservation information or the channel sensing information from the second UE; and
transmit the at least one of the resource reservation information or the channel sensing information to the second UE in response to the request, and
wherein the request received from the second UE comprises a request for the at least one of the resource reservation information or the channel sensing information for one or more other UEs using a resource pool being overlapping with that used by the second UE but operating on a different radio access technology (RAT).

3. The apparatus of claim 1,
wherein the at least one of the resource reservation information or the channel sensing information is used by the second UE to avoid sensing a whole or part of resource pool by excluding one or more resources based on the at least one of the resource reservation information or the channel sensing information.

4. The apparatus of claim 1,
wherein the at least one of the resource reservation information or the channel sensing information is obtained by the at least one first UE by performing a channel sensing, and
wherein the resource reservation information is obtained by the first UE based on decoding of sidelink control information (SCI) included in a sidelink signal.

5. The apparatus of claim 1,
wherein the at least one of the resource reservation information or the channel sensing information is obtained by the at least one first UE by performing a channel sensing, and
wherein the channel sensing information comprises at least one of a received signal strength indicator (RSSI) or a reference signal received power (RSRP) of a sidelink signal.

6. The apparatus of claim 1,
wherein the first UE comprises a plurality of UEs, and the at least one of the resource reservation information or the channel sensing information comprises a plurality of data sets received from the plurality of UEs at the same time or at different times in which time differences are within a predetermined threshold, and
wherein the processor is configured to execute the instruction stored in the memory to:
map a physical location of each of the plurality of UEs to at least one of a cell identification (ID), a zone ID, or a roadside unit (RSU) ID.

7. The apparatus of claim 1,
wherein the processor is further configured to execute the instruction stored in the memory to:
determine data sets corresponding to the second UE based on a mapping between a location of the second UE and a location of the first UE.

8. A user equipment (UE) for providing location information and at least one of resource reservation information or channel sensing information in a sidelink communication, the UE comprising:
a memory storing an instruction; and
a processor configured to execute the instruction stored in the memory to:
perform a sidelink channel sensing operation to obtain the at least one of the resource reservation information or the channel sensing information, the at least one of the resource reservation information or the channel sensing information being associated with location information of the UE; and
report the location information and the at least one of the resource reservation information or the channel sensing information, to an apparatus in the sidelink communication so as to enable the apparatus to provide the location information and the at least one of the resource reservation information or the channel sensing information, to another UE.

9. The UE of claim 8, wherein the location information, and the at least one of the resource reservation information or the channel sensing information, are reported to the apparatus periodically, or instantly whenever the UE has the location information, and the at least one of the resource reservation information or the channel sensing information, based on a configuration or a pre-configuration for the UE.

10. The UE of claim 8,
wherein the location information and the at least one of the resource reservation information or the channel sensing information are reported to the apparatus based on a triggering event that triggers the reporting, and
wherein the triggering event is configured by an RRC reconfiguration message or in a MAC protocol control element, or as an indication in a NAS protocol data unit, or is pre-configured in the UE.

11. The UE of claim 8,
wherein the UE operates on a long-term evolution (LTE) network, and
wherein the location information and the at least one of the resource reservation information or the channel sensing information are reported to the apparatus using a mobile originated early data transmission (MO-EDT) or a pre-configured uplink resource (PUR).

12. The UE of claim 8,
wherein the UE operates on a new radio (NR) network, and
wherein the location information and the at least one of the resource reservation information or the channel sensing information are reported to the apparatus using a small data transmission (SDT) procedure.

13-17. (canceled)

18. A method for forwarding at least one of resource reservation information or channel sensing information in a sidelink communication, the method comprising:
receiving, from at least one first user equipment (UE), the at least one of the resource reservation information or the channel sensing information, obtained by the at least one first UE;
storing the at least one of the resource reservation information or the channel sensing information; and
transmitting, to a second UE, the received at least one of the resource reservation information or the channel sensing information.

19-20. (canceled)
